(19) United States
(12) Patent Application Publication
(10) Pub. No.: US 2019/0186678 A1
(43) Pub. Date: Jun. 20, 2019

(54) FIXED SUPPORT FOR FROST PREVENTION MACHINE WITH SIDE EXTENDING PLATE AT BOTTOM

(71) Applicant: JiangSu University, Jiangsu (CN)

(72) Inventors: Lili DONG, Jiangsu (CN); Yongguang HU, Jiangsu (CN); Quan Bu, Jiangsu (CN)

(73) Assignee: JiangSu University, Jiangsu (CN)

(21) Appl. No.: 16/099,691

(22) PCT Filed: Apr. 21, 2017
(86) PCT No.: PCT/CN2017/081398

§ 371 Date: Nov. 8, 2018

(30) Foreign Application Priority Data
May 9, 2016 (CN) 201610300961.3

(51) Int. Cl. F16M 5/00; F16M 7/00; A01G 13/08

(52) U.S. Cl. CPC F16M 5/00; A01G 13/08; F16M 7/00

(57) ABSTRACT

The present invention discloses a frost prevention machine fixed support with a side extending plate at a bottom, including a frost prevention machine, a connecting support, and a pedestal. The connecting support includes an anti-tilting guide barrel, a fixed pillar, a rib plate, and a connecting plate. The pedestal includes a pedestal plate, a side extending adjusting rod, a pedestal bolt, and a side extending plate. The pedestal bolt (33) is used for fixing the connecting support with the pedestal, and the side extending adjusting rod is used for driving and fixing the side extending plate.

### BACKGROUND

### Technical Field

The present invention relates to a device for the frost prevention machine column, which relates to a fixed device and method of a stand column of the frost prevention machine used in tea (fruit) garden, which belongs to the technical field of agricultural machinery.

### Description of Related Art

China has a long history of tea planting and drinking. The growth and development of tea trees requires a warm and moist climate. The germination of tea buds in early spring is easy to be affected by cold spell in later spring, which reduces quality and production of the tea. In recent years, research on tea tree defrosting technology has been carried out rapidly in China. The research shows that frost prevention effect can be achieved by using the frost prevention machine to conduct airflow disturbance from top to bottom.

At present, commonly used methods for fixing the frost prevention machine column are as below. (1) Manual digging a pit with a certain depth in a location where the frost prevention machine is installed. Pouring concrete in the pit, and a top of the concrete is provided with an anchor bolt. A column bottom flange is fixed on a foundation of the concrete by the anchor bolt. The disadvantage of this method is that labor intensity is high and installation efficiency of the frost prevention machine is low. (2) Use tools to dig a pit with a certain depth and a diameter slightly bigger than a diameter of the column in a location where the frost prevention machine is installed. The frost prevention machine column is placed in the pit with a body of the column being kept upright, and is buried via filling of soil or concrete after adjusting the direction. The disadvantage of this method is that: in order to guarantee working requirement of the column, the pit can only has the diameter slightly bigger than that of the column, such that in late burying, a gap between soil and column is hard to eliminate. The gap will further increase due to vibration and wind generated from frost prevention machine in the process of using machine, this severely reduces safety of using the frost prevention machine and work efficiency. To solve the problem of high labor intensity and low efficiency of digging the pit, the present invention provides the pedestal plate punched into the soil to replace the deep pit fixing frost prevention machine, which greatly reduces the labor intensity and improves the installation efficiency of the frost prevention machine. In addition, Chinese utility model patent CN201120394200.1 discloses a fixing device for a stand column of the frost prevention machine for plant, which includes several root stand institutions disposed at a bottom of the stand column. The root stand mechanisms include a steel root beam formed by a metal sheet beam transversely bent into trough type, and a U-shaped hoop. A pair of positioning rods is disposed on a middle of the steel root beam. A lower part of the column is positioned between a bunch of positioning rods, which are fixed vertically to the steel root beam through the U-shaped hoop. This method requires digging bigger and deeper pits, which increase the labor intensity and requirement of installation of the device itself is high and cost is relatively high. The common feature of the above method is that it is necessary to dig a small diameter and high precision deep pit in the installation position of frost prevention machine, and it is labor intensive, time consuming and costly. The present invention adopts the method of driving the pedestal plate to insert into the soil to avoid the work of digging deep pits, thus it reduces the labor intensity, and improves the installation efficiency of the frost prevention machine columns. The height of frost prevention machine to the ground needs to reach 6.7 meters to meet the frost prevention effect of the frost prevention machine. Non-standard pipe is adopted in the conventional frost prevention machine column since the standard length of the pipe is 6 meters, which has a high cost. The use of the connecting support provided by the present invention can make the frost prevention machine column adopt standard pipe material, which can save 50% of the fabricating cost.

### SUMMARY

The purpose of the present invention is to provide a fixed support for the frost prevention machine and its usage method, which has a simple structure and is convenient in installation, so as to reduce labor intensity and installation time of the installation process of the frost prevention machine, and effectively prevent rotation and tilt of the frost prevention machine column, thereby reducing material cost, manufacturing and installation costs, and improving economic efficiency, and facilitating transportation and storage.

The technical solutions of the present invention are as follows. A fixed support is adapted for a frost prevention machine with a side extending plate at bottom thereof. The fixed support includes a frost prevention machine 1, a connecting support 2, and a pedestal 3. The frost prevention machine column 11 is a standard pipe with a length of 6 m, and a lower end of the frost prevention machine column 11 has two or three groups of holes, which is used for plug welding connection the frost prevention machine column 11 with the anti-tilting guide barrel 21. The connecting support 2 includes an anti-tilting guide barrel 21, a fixed pillar 22, a rib plate 23, and a connecting plate 24. An outer diameter of the anti-tilting guide barrel 21 is 0.5 mm-1 mm smaller than an inner diameter of the frost prevention machine column 11 and an inner diameter of the fixed pillar 22. A length of the anti-tilting guide barrel 21 is more than 200 mm, and two ends of the anti-tilting guide barrel 21 are provided with chamfer. An outer diameter of the fixed pillar 22 is equal to an outer diameter of the frost prevention machine column 11. There are two or three groups of small holes on an upper end of the fixed pillar 22 are used for plug welding. An outer edge of the connecting plate 24 has notches. During the assembly, the anti-tilting guide barrel 21 is first placed around 200 mm above the upper end of the fixed pillar 22. The anti-tilting guide barrel 21 and the fixed pillar 22 are fixed by the method of plug welding. The fixed pillar 22 is welded vertically in a center of the connecting plate 24, and the rib plate 23 is welded between the fixed pillar 22 and the connecting plate 24. The pedestal 3 includes a pedestal plate 31, a side extending adjusting rob 32, a pedestal bolt 33, and a side extending plate 36. An inner side of the pedestal plate 31 is provided with an upper hole 34 and a lower hole 35, and an outer edge of the pedestal plate 31 is provided with a hole for installation of the pedestal bolt 33. The side extending adjusting rob 32 is a wedge-shaped plate, an upper end of the side extending adjusting rob 32 is provided with a hole, a middle of the side extending adjusting rob 32 is provided with two narrow guide grooves, and an outer edge of the side extending adjusting rob 32 is provided with 3 or 4 grooves. In order to correspond with these features, a hole and two guide pin shaft 38 are provided at a corresponding position on the pedestal plate, and three or four projections are provided on the side extending plate 36. The two guide grooves on the side extending adjusting rod 32 chutes on the two guide pin shaft 38 of the pedestal plate 31, and the side extending adjusting rod 32 can move in a predetermined trajectory. The side extending plate 36 is mounted on the pedestal plate 31 through the pin shaft 37, and the side extending plate 36 is rotatable around the pin shaft 37. When installation, dig a shallow pit in the corresponding position. Each pedestal plate 31 is punched into the soil with a certain depth successively after location of each pedestal plate 31 is determined. When an upper end of the lower hole 35 is close to the ground, a connecting ring will be stuck into the lower holes 35 of each pedestal plate 31 to fix each pedestal plate 31. Punching until upper hole 34 is close to the ground and the connecting ring is attached to the upper hole 34 of each pedestal plate 31, and continues punching each pedestal plate 31 in turn until the two upper holes close to the ground. Punch down the side extending adjusting rod 32 until the upper hole is aligned with corresponding hole on the pedestal plate 31, and a bolt is installed in the hole to fix the side extending adjusting rod 32 and the pedestal plate 31. The side extending plate 36 is outwardly deployed, and the side extending adjusting rob 32 has a groove which cooperates with a projection on the side extending plate 36. Under the action of the upper end bolt connection of the side extending adjusting rod 32, a position of the side extending plate 36 is fixed. After the installation of the pedestal 3 is completed, the connecting support 2 is fixed on the pedestal 3 by using the pedestal bolt 33 in a symmetrical installation method. Finally, the frost prevention machine column 11 is put on the anti-tilting guide barrel 21, and the anti-tilting guide barrel 21 and the frost prevention machine column 11 are fixed by the means of plug welding.

Preferably, a cross-section shape of the pedestal is cross-shaped.

Preferably, the guide groove on the side extending adjusting rob 32 is preferably a rectangular groove.

Preferably, fixing method between the anti-tilting guide barrel 21 and the fixed pillar 22, and fixing method between the anti-tilting guide barrel 21 and the frost prevention machine column 11 are plug welding.

The frost prevention machine fixed support with side extending plate at the bottom in the present invention has the advantage of simple structure and convenient installation, it not only reduces the labor intensity installing, but also reduces the installation and manufacturing cost of the frost prevention machine, and improves the installation efficiency and economic benefit. The use of connecting supports enables the standard pipe material to replace the non-standard pipe material, and facilitate to transportation and storage, can greatly save the fabricating cost nearly 50% compared with the non-standard pipe. The method of punching the pedestal plate into the soil to in the present invention solves the problem of digging small diameter deep hole in common method, reduces the labor intensity, and improves the installation efficiency of the frost prevention machine columns. The use of the wedge-shaped pedestal plate with side extending plate to raises the anti-torsion ability and anti-dumping ability. In addition, the hole in the pedestal plate and the hole in the side extending plate can connect the soil inside and outside the pedestal into a whole, which enhances stability of the pedestal and reduces damage to the soil. The present invention provides a device which can be used for fixing the frost prevention machine column.

### BRIEF DESCRIPTION OF THE DRAWINGS

FIG. 1 is a schematic overall installation structure view of a frost prevention machine according to the present invention.

FIG. 2 is a schematic structure view of the frost prevention machine according to the present invention.

FIG. 3 is a schematic installation structure view of a connecting support and a pedestal plate according to the present invention.

FIG. 4 is a schematic structure view of the connecting support according to the present invention.

FIG. 5 is a schematic installation structure view of the pedestal plate according to the present invention.

FIG. 6 is a schematic structure view of the pedestal plate according to the present invention.

FIG. 7 is a schematic structure view of a side extending adjusting rob according to the present invention.

FIG. 8 is a schematic structure view of the side extending plate according to the present invention.

FIG. 9 is a schematic structure view of a pedestal bolt according to the present invention.

### DESCRIPTION OF THE EMBODIMENTS

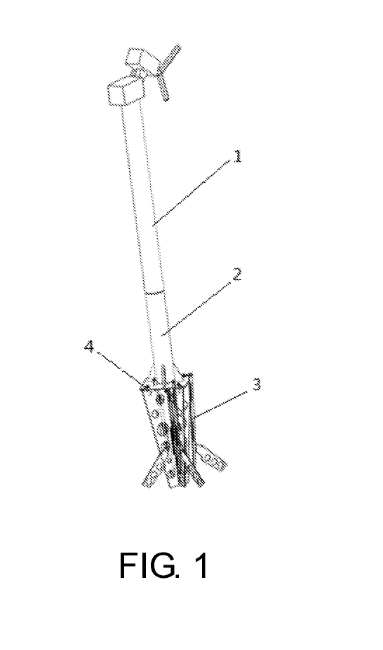

As shown in FIG. 1, this machine includes a frost prevention machine 1, a connecting support 2 and a pedestal 3. The combined installation method meets height requirement and reliability requirement of frost prevention machine. The frost prevention machine column 11 is mounted on the anti-tilting guide barrel 21 is fixed by plug welding. The connecting support 2 and the pedestal 3 are fixed by a pedestal bolt 33.

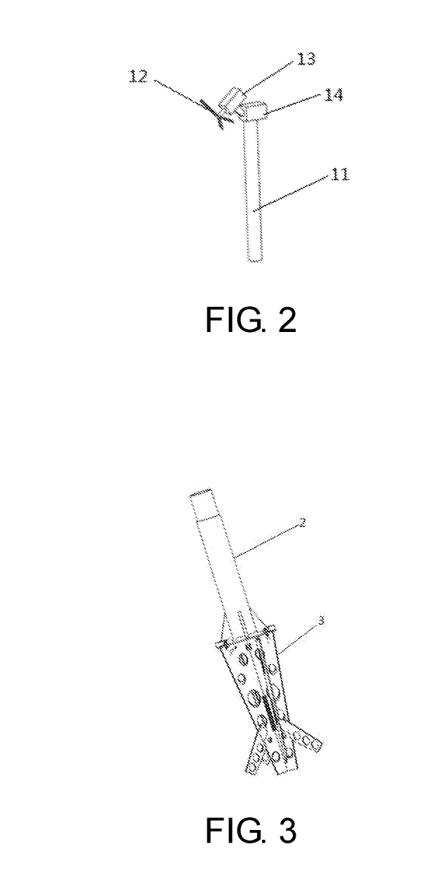

As shown in FIG. 2, the frost prevention machine includes a frost prevention machine column 11, a frost prevention machine blade 12, a frost prevention machine motor 13, and a frost prevention machine connection part 14. The frost prevention machine column 11 is a standard pipe with a length of 6 m.

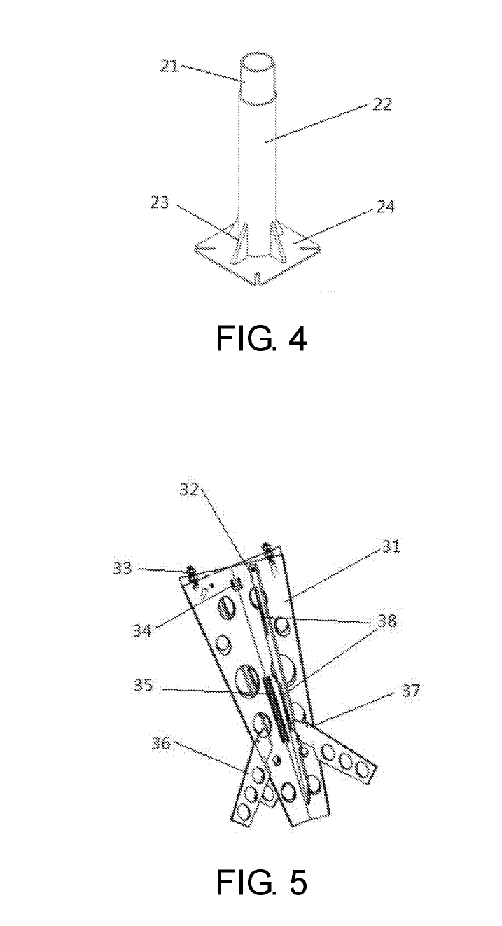

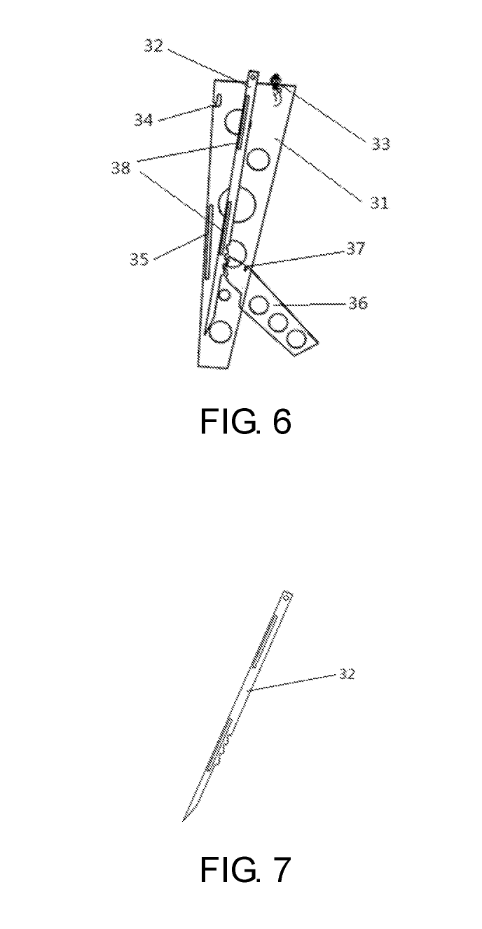

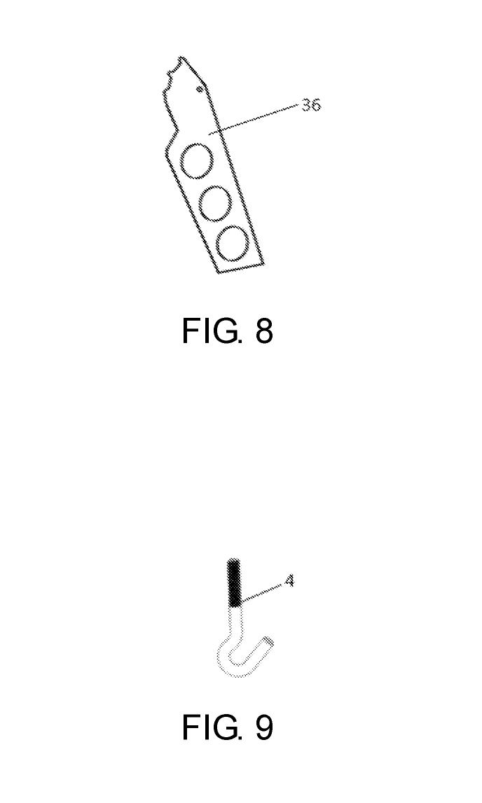

As shown in FIG. 4, the connecting support 2 includes an anti-tilting guide barrel 21, a fixed pillar 22, a rib plate 23, and a connecting plate 24 fixed to each other. An outer diameter of the anti-tilting guide barrel 21 is 0.5 mm-1 mm smaller than an inner diameter of the fixed pillar 22. An upper end of the fixed pillar 22 has 2 or 3 groups of small holes. The fixed pillar 22 is welded vertically in a center of the connecting plate 24, and then the rib plate 23 is welded between the fixed pillar 22 and the connecting plate 24 to enhance anti-dumping ability of the fixed pillar 22.

As shown in FIG. 5, the pedestal 3 includes a pedestal plate 31, a side extending adjusting rob 32, the pedestal bolt 33, and a side extending plate 36. The pedestal plate 31 is connected to each other through connecting rings. The guide groove on the side extending adjusting rob 32 engages the guide pin shaft 38 are fixed by bolts. The side extending adjusting rob 32 is fixed on the pedestal plate 31 through an upper hole on the side extending adjusting rob 32 and a corresponding hole on the pedestal plate 31. The side extending plate 36 is fixed on the pedestal plate 31 through the pin shaft 37, and is rotatable around the pin shaft 37. A lower end of the side extending adjusting rob 32 is provided 3 or 4 grooves for matching 3 or 4 projections on the side extending plate 36.

The structure, functionality, and processing of the present invention are further described below with reference to the accompanying drawings and the concrete implementation examples. However, claimed scope of this present invention includes but not limited to that.

A fixed support for frost prevention machine with a side extending plate at bottom according to the present invention can overcome difficulties of the high precision of digging aperture, deep pit with a small diameter and the backfill compaction in the commonly used fixed installation methods of the frost prevention machine by punching the pedestal into the soil, and reduces the labor intensity and improves installation efficiency. The use of connecting support enables the standard pipe can replace the conventional non-standard pip, which was originally used to meet a height of the frost prevention machine, thereby greatly saving the fabricating costs, and facilitating transportation and storage. The side extending plate 36 at a bottom of the pedestal plate 31 extends outward, which increases the stability of the frost prevention machine fixed support. The hole in the pedestal plate connects the soil inside and outside of the pedestal into a whole, which enhances the stability of the pedestal and reduces the damage to the soil. The present invention provides a device which can be used for fixing the stand column of the frost prevention machine, especially suitable for using in land with few stone.

The installation process of the frost prevention machine is as follows. Firstly, dig a shallow pit in a corresponding installation position. Secondly, the pedestal plate 31 is spliced together and formed. Thirdly, each pedestal plate 31 is punched into the soil with a certain depth successively after location of each pedestal plate 31 is determined. Fourthly, when the upper end of the lower hole 35 is close to the ground, the connecting ring will be stuck into the lower hole 35 of each pedestal plate 31. Fifthly, continues punching until the upper hole 34 is close to the ground, and the connecting ring attaches the upper hole 34 of each pedestal plate 31. Then, the side extending adjusting rob 32 is struck downward. When the side extending adjusting rob 32 is moved downward, the wedge-shaped tip pushes the side extending plate 36 outward, and the side extending adjusting rob 32 is lowered by a certain distance (about 55 mm). An oblique thrust of the side extending adjusting rob 32 will no longer act to push the side extension plate 36 outward. At this time, a first projection of the side extending adjusting rob 32 moves downward to a first projection of the side extending plate 36, which will continue to extend the side extending plate 36 outward, thereby reinforcing the frost prevention machine. When the first projection of the side extending adjusting rob 32 no longer acts to push the side extending plate 36 outward, a second engagement groove of the side extending adjusting rob 32 just moves downward to a second projection of the side extension plate 36. From the beginning, continue to extend the side extensions 36 to enhance anti-dumping and stabilizing performance of the anti-frost machine. An upper end hole of the side extending adjusting rod 32 is aligned with the corresponding hole on the pedestal plate 31, and the bolt is installed in the hole to fix the side extending adjusting rod 32 and the pedestal plate 31. The side extending plate 36 is outwardly deployed and the side extending adjusting rob 32 has a groove which cooperates with the projection on the side extending plate 36. Under the action of the upper end bolt connection of the side extending adjusting rod 32, the position of the side extending plate 36 is fixed. After the installation of the pedestal 3 is completed, the connecting support 2 is fixed on the pedestal 3 by using the pedestal bolt 33 in a symmetrical installation method. Finally, the frost prevention machine column 11 is put on the anti-tilting guide barrel 21, and the anti-tilting guide barrel 21 and the frost prevention machine column 11 are fixed by the means of plug welding.

The embodiment of the preferred implementation manners of this present invention, however, this present invention includes but not limited to the foregoing implementation manners. Any obvious improvements, replacements or variations that can be made by a person skilled in the art without departing from the substantial content of the present invention fall within the protection scope of the present invention.

1. A fixed support is adapted for a frost prevention machine, and has a side extending plate at a bottom thereof, the fixed support comprising a frost prevention machine, a connecting support and a pedestal, wherein the connecting support includes an anti-tilting guide barrel, a fixed pillar, a rib plate, and a connecting plate, the pedestal includes a pedestal plate, a side extending adjusting rob, a pedestal bolt, and the side extending plate.

2. The fixed support for frost prevention machine according to claim 1, wherein an outer diameter of the anti-tilting guide barrel is 0.5 millimeters-1 millimeter smaller than an inner diameter of the fixed pillar and an inner diameter of an frost prevention machine column, and an outer diameter of the fixed pillar is equal to an outer diameter of the frost prevention machine column.

3. The fixed support for frost prevention machine according to claim 1, wherein a length of the anti-tilting guide barrel is more than 200 millimeters, two ends of the anti-tilting guide barrel are provided with chamfers, the anti-tilting guide barrel is installed into and contacts the fixed pillar and the frost prevention machine column with contact lengths of more than 200 millimeters, fixation between the anti-tilting guide barrel and the frost prevention machine column is plug welding, and fixation between the anti-tilting guide barrel and the fixed pillar is plug welding.

4. The fixed support for frost prevention machine according to claim 1, wherein a cross-sectional shape of the pedestal is cross-shaped or Y-shaped.

5. The fixed support frost prevention machine according to claim 4, wherein the pedestal plate includes a pin shaft, a guide pin shaft, and a hole for mounting corresponding parts.

6. The fixed support according to claim 5, wherein two guide grooves on the side extending adjusting rob engage the guide pin shaft, so that the side extending adjusting rob moves along a predetermined trajectory; after each pedestal plate is driven into soil, the side extending adjusting rob is punched down until an upper hole thereof is aligned with corresponding holes on the pedestal plate, the side extending adjusting rob is fixed to the pedestal plate by bolts.

7. The fixed support for frost prevention machine according to claim 5, wherein the side extending plate is installed on the pedestal plate through the pin shaft, and is rotatable around the pin shaft; when the side extending adjusting rob moves downward, the side extending plate expands outward, when the side extending adjusting rob is fixed to the pedestal plate by bolts, projections on the side extending plate matches grooves on the side extending adjusting rob (32), and the side extending plate is fixed.
